(19) United States
(12) Patent Application Publication
(10) Pub. No.: US 2008/0147963 A1
(43) Pub. Date: Jun. 19, 2008

(54) Disk array device

(75) Inventors: Wen-Sen Tsai, Hsinchu County (TW); Chun-Hung Shen, Hsinchu County (TW)

Correspondence Address: BACON & THOMAS, PLLC, 625 SLATERS LANE, FOURTH FLOOR, ALEXANDRIA, VA, 22314, US

(73) Assignee: ACCUSYS. INC., HSINCHU (TW)

(21) Appl. No.: 11/639,268

(22) Filed: Dec. 15, 2006

(51) Int. Cl. G06F 12/00

(52) U.S. Cl. 711/103; 711/E12.001

(57) ABSTRACT

The present invention discloses a disk array device including a connection interface, a disk array controller and at least one set of flash memories. The connection interface is electrically connected to an electronic appliance, such that the electronic appliance can be connected to the disk array device through the connection interface for an application, and the disk array controller controls the storage and reading of data in the disk array device. The flash memories are provided for storing and backing up data, so that data can be transmitted between the disk array device and the electronic appliance. The disk array device developed from the flash memories has the features of a quiet and fast storage, a light, thin, short and compact design, and a convenient carry, so as to provide better data storage and backup.

### BACKGROUND OF THE INVENTION

1. Field of the Invention

The present invention relates to a disk array device, and more particularly to a disk array device that is developed from flash memories and comes with the features of a quiet and fast storage, a light, thin, short and compact design, and a convenient carry, so as to provide better data storage and backup.

2. Description of the Related Art

Disk is one of the present popular information storage devices that features an advantage of a large capacity and becomes a common necessary storage device. In recent years, the capacity, access speed and reliability of the disk are improved greatly, but the improvements still cannot meet user requirements for the security of important document files, and thus finding a way to protect important document files becomes a bottleneck of the development of computer systems.

To meet the requirements for protecting important document files, various different measures were proposed. For instance, a redundant array of inexpensive disks (RAID) proposed by a group of researchers of U. C. Berkeley in 1987 is one of the proposals.

The foregoing disk arrays for storing and protecting important document files are divided into different levels including RAID0, RAID 1, RAID 2, RAID 3, RAID 4 and RAID 5 according to different management methods. Referring to FIG. 1 for a device that completes data storage and different levels of backup by a hard disk, the device has an electronic appliance 200 connected to a corresponding connection interface 110 on a disk array system 100 through a transmission line 211. The disk array system 100 has a disk array controller 120 connected to at least a group of hard disks 130, such that electronic appliance 200 can control the hard disks 130 by the disk array controller 120 to access and back up data. Although the disk array system 100 can store and back up a large number of data, the hard disk 130 is used as a storage medium and the hard disk 130 is a mechanical device, and thus it has a characteristic of being affected easily by mechanical damages and vibrations. When the disk array system 100 executes a huge data storage or backup, the execution speed will be affected by the rotation of a mechanical motor and the movement of a pickup head. Therefore, the use of such disk array system 100 is not as good as expected.

### SUMMARY OF THE INVENTION

In view of the shortcomings of prior art, the inventor of the present invention based on years of experience in the related industry to conduct extensive researches and experiments, and finally developed a disk array device in accordance with the present invention.

Therefore, it is a primary objective of the present invention to provide a disk array device comprising a connection interface, a disk array controller and at least one set of flash memories. The connection interface is electrically coupled to an electronic appliance through the connection interface, so that data can be transmitted between the disk array device and the electronic appliance. The disk array controller is electrically coupled to the electronic appliance through the connection interface for controlling the storage and reading of data in the disk array device. The flash memory is provided for storing and backing up data, so that the data can be transmitted between the disk array device and the electronic appliance. The disk array device developed from flash memories has the features of a quiet and fast storage, a light, thin, short and compact design, and a convenient carry, so as to provide better data storage and backup.

To make it easier for our examiner to understand the present invention, the following embodiment accompanied with the related drawings are described in details.

### BRIEF DESCRIPTION OF THE DRAWINGS

FIG. 1 is a schematic view of a structure of the prior art; and

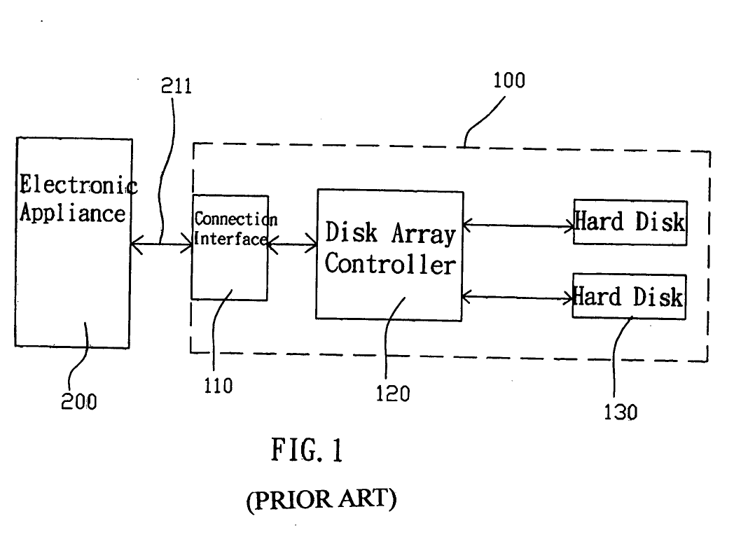

FIG. 2 is a schematic view of a structure of the present invention.

### DETAILED DESCRIPTION OF THE PREFERRED EMBODIMENTS

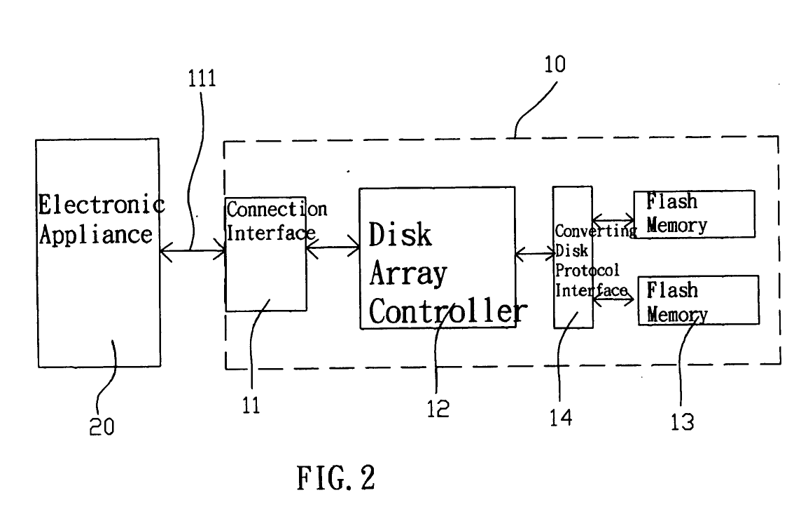

Referring to FIG. 2 for a disk array device of the present invention, the disk array device 10 is either an interface card or any other standalone device integrated with an electronic appliance 20. The disk array device 10 comprises a connection interface 11, a disk array controller 12 and at least one set of flash memories 13, wherein the connection interface 11 is electrically coupled to the electronic appliance 20, and the connection interface 11 can support different transmission protocols such as SATA, PATA, USB and IEEE1394. The connection interface 11 is connected to a transmission line 111, so that data can be transmitted between the disk array device 10 and the electronic appliance 20.

The disk array controller 12 can support a storage function of the flash memory 13 including the flash IDE disk, flash SATA disk, compact flash (CF) card and PCMCIA ATA card protocols. The disk array controller 12 is electrically connected to the electronic appliance 20 through the connection interface 11 for controlling the storage and reading of data in the disk array device 10.

The disk array controller 12 is electrically coupled to at least one set of flash memories 13, and the flash memories 13 are provided for storing and backing up data, and the flash memories 13 are electrically coupled to the disk array controller 12 through a converting disk protocol interface 14, wherein the converting disk protocol interface 14 converts the input/output of data of the memories into a hard disk transmission protocol such as SATA, SCSI or PATA, so that the flash memories 13 can convert a stored data into a data acceptable by the electronic appliance 20 through the connection of the connection interface 11 and the conversion of the converting disk protocol interface 14.

In addition, the disk array device 10 has a light emitting diode (LED), so that the LED can indicate an operating status, and the disk array controller 12 of the disk array device 10 can support all of the functions including the hot swap function of the storage device defined by different levels of RAID of the prior art. The disk array device of this embodiment also can support a flash memory, an online automatic data rebuild (without the need of performing the operations offline) and an online bad sector repair, and the disk array device can be installed selectively to the electronic appliance 20 to support a master disk or a slave disk with PATA interface.

The disk array controller 12 can be set to a level of JBOD, N-RAID, RAID 0, RAID 1, RAID 2, RAID 3, RAID 4, RAID 5, RAID 6, RAID 7 or any RAID level according to the data storage and backup management method for storing document files, and the converting disk protocol interface 14 converts the data of the flash memory 13 into the data that can support a hard disk protocol such as SATA, SCSI and PATA, and the data can be sent to the electronic appliance through the connection interface 11.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A disk array device, coupled to an electronic appliance, for storing data of said electronic appliance, and said disk array device comprising:
a connection interface, electrically coupled to said electronic appliance, for transmitting data between said disk array device and said electronic appliance through said connection interface; and
a disk array, connected to said connection interface, for electrically connecting said electronic appliance through said connection interface, and said disk array having a disk array controller coupled to a plurality of flash memories, for controlling the storage of said flash memories and reading data;
thereby, the control of said disk array controller uses said flash memory as a disk to store data into said flash memory by an array method.

2. The disk array device of claim 1, wherein said disk array device has a converting disk protocol interface, for converting an input/output of data of said memory into a hard disk transmission protocol.

3. The disk array device of claim 1, wherein said disk array device is the in form of an interface card to be inserted to said electronic appliance.

4. The disk array device of claim 1, wherein said disk array device is connected to said electronic appliance by a transmission line through said connection interface.

5. The disk array device of claim 1, wherein said flash memory uses a JBOD, N-RAID, RAID 0, RAID 1, RAID 2, RAID 3, RAID 4, RAID 5, RAID 6 or RAID 7 to access files.

6. The disk array device of claim 1, wherein said connection interface supports a SATA, PATA, SCSI, USB, or IEEE 1394 communication protocol.

7. The disk array device of claim 1, wherein said disk array controller supports a flash memory storage function including flash IDE disk, flash SATA disk, compact flash (CF) card and PCMCIA ATA card protocols.

8. The disk array device of claim 1, wherein said disk array device supports a hot swap function for said flash memory.

9. The disk array device of claim 1, wherein said disk array device installs a light emitting diode for indicating an operating status.

10. The disk array device of claim 1, wherein said disk array device supports an online automatic data rebuild for said flash memory.

11. The disk array device of claim 1, wherein said disk array device supports an online bad sector repair for said flash memory.

12. The disk array device of claim 1, wherein said disk array device supports a PATA interface of a master disk or a slave disk selectively installed to said electronic appliance.

13. The disk array device of claim 2, wherein said converting disk protocol interface supports SATA, SCSI and PATA protocols.
